(19) United States
(12) Patent Application Publication
(10) Pub. No.: US 2008/0168116 A1
(43) Pub. Date: Jul. 10, 2008

(54) PROCESSING SPEED CALCULATION METHOD, CALCULATION DEVICE AND PROGRAM

(75) Inventors: Mitsuru ODA, Kawasaki (JP); Youji KOHDA, Kawasaki (JP); Masashi UYAMA, Kawasaki (JP); Masatomo YASAKI, Kawasaki (JP); Satoru WATANABE, Kawasaki (JP); Hiroki ICHIKI, Kawasaki (JP); Yasuhide MATSUMOTO, Kawasaki (JP); Madoka MITSUOKA, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi, Kanagawa (JP)

(21) Appl. No.: 11/970,080

(22) Filed: Jan. 7, 2008

(30) Foreign Application Priority Data
Jan. 6, 2007 (JP) 2007-00876

(51) Int. Cl. G06F 17/17; G06F 15/16

(52) U.S. Cl. 708/290; 709/201

(57) ABSTRACT

A calculation device calculates information relating to a processing speed for a plurality of processing devices which execute various kinds of process in response to a request from a process request device. The calculation device includes a response time calculation part which calculates a response time for each processing device, based on a time which each processing device needs for the process, a permissible time calculation part which calculates a permissible time for each item of identification information corresponding to the process request device, based on a time from a start of a request for the process, from the process request device to the processing device, to an interruption of the request for the process, and a calculation part which calculates information relating to a processing speed, for each processing device, for each item of identification information.

### TECHNICAL FIELD

The present invention relates to a processing speed calculation method which calculates, by means of a calculation device, information relating to a processing speed for a plurality of processing devices which execute various kinds of process in response to a request from a process request device, the calculation device, and a program for causing the calculation device to function as a computer.

### BACKGROUND OF INVENTION

In recent years, online services, via a communication network, by means of an internet or the like, have become widespread. In the online services, a variety of processes being executed by a plurality of processing devices, results thereof are transmitted to a user's process request device. For example, in an internet banking service, a plurality of services such as, for example, a deposit service, a withdrawal service, a balance inquiry service, a fixed-term deposit service, a foreign currency deposit service, an investment trust service, and a transfer service are provided via the internet.

Although these services are executed by means of the plurality of processing devices, depending on a time of day or a kind of service, there is a case in which a processing capability decreases, or a case in which a communication environment deteriorates. For example, in the event that it is the end of a month, a processing capability of a processing device which executes the transfer service, and a communication speed relating to the processing device, decrease. Contrarily, there is a case in which, even though it is the end of the month, no problem at all occurs in a processing device which executes the investment trust service.

To date, a method has been proposed which measures a response time for each processing device, and detects an existence or otherwise of an occurrence of a performance decrease or failure from a response time measurement result (for example, refer to JP-A-2006-195709, JP-A-2003-163698 and JP-A-2001-325223). A response measurement device described in JP-A-2006-195709 transmits a request to each Web AP server used by an integrated Web AP server, measures a response time thereto, and notifies a monitoring server of a measurement result. Then, the monitoring server detects a Web AP server at which the performance decrease or failure has occurred from the response time measurement result notified by the response measurement device.

Heretofore known technology is disclosed in, for example, JP-A-2006-195709, JP-A-2003-163698 and JP-A-2001-325223.

However, the technology described in JP-A-2006-195709, JP-A-2003-163698 and JP-A-2001-325223 merely considering the response times and the like of the web servers and the like, and not considering a status of communication between each user's process request device and the processing device, or a time the user may wait for a process, or the like, there has been a problem in that it is not possible to provide a more user friendly service. That is, given that a time from a start to a finish of a service provision varies depending on a communication time of day and on a size of a processing load, depending on the user, while there exist those who can wait a long time, there also exist those who can only wait a short time.

The invention having been conceived bearing in mind these kinds of circumstance, an object thereof is to provide a processing speed calculation method and calculation device which, by calculating information relating to a processing speed which considers the response time in the processing device, and a communication time between the process request device and the processing device, as well as a permissible time for which the user can interrupt the process, are capable of providing information relating to processing speeds, customized for each individual user, and more appropriate for each individual processing device which executes a service, and a program for causing the calculation device to function as a computer.

### SUMMARY

According to a first aspect of the present invention, a processing speed calculation method for calculating, by means of a calculation device, information relating to a processing speed for a plurality of processing devices which execute various kinds of process in response to a request from a process request device, includes:

a step of transmitting a time which each processing device needs for the process to the calculation device, by means of each processing device;

a step of transmitting a time from a start of a request for the process, from the process request device to the processing device, to an interruption of the request for the process, correlated to identification information corresponding to the process request device, to the calculation device by means of the process request device;

a step of transmitting a communication time needed for a transmission and reception of information between the process request device and the processing device to the calculation device, by means of the process request device;

a response time calculation step which calculates a response time for each processing device, by means of the calculation device, based on the transmitted time which each processing device needs for the process;

a permissible time calculation step which calculates a permissible time for each item of identification information, by means of the calculation device, based on the transmitted time from the request start to the request interruption corresponding to the identification information; and

a calculation step which calculates, by means of the calculation device, information relating to a processing speed, for each processing device, for each item of identification information, based on the transmitted communication time, the response time calculated by means of the response time calculation step, and the permissible time corresponding to the identification information calculated by means of the permissible time calculation step.

According to a second aspect of the present invention, a calculation device for calculating information relating to a processing speed for a plurality of processing devices which execute various kinds of process in response to a request from a process request device, includes:

a response time calculation part which calculates a response time for each processing device, based on a time which each processing device needs for the process;

a permissible time calculation part which calculates a permissible time for each item of identification information corresponding to the process request device, based on a time from a start of a request for the process, from the process request device to the processing device, to an interruption of the request for the process; and

a calculation part which calculates information relating to a processing speed, for each processing device, for each item of identification information, based on the response time calculated by the response time calculation part, and the permissible time corresponding to the identification information calculated by the permissible time calculation part.

According to a third aspect of the present invention, a calculation device for calculating information relating to a processing speed for a plurality of processing devices which execute various kinds of process in response to a request from a process request device, includes:

a response time calculation part which calculates a response time for each processing device, based on a time which each processing device needs for the process;

a permissible time calculation part which calculates a permissible time for each item of identification information corresponding to the process request device, based on a time from a start of a request for the process, from the process request device to the processing device, to an interruption of the request for the process;

an acquisition part which acquires a communication time needed for a transmission and reception of information between the process request device and the processing device; and

a calculation part which calculates the information relating to the processing speed, for each processing device, for each item of identification information, based on the communication time acquired by the acquisition part, the response time calculated by the response time calculation part, and the permissible time corresponding to the identification information calculated by the permissible time calculation part.

According to a fourth aspect of the present invention, a program which causes a calculation, by means of a computer, of information relating to a processing speed for a plurality of processing devices which execute various kinds of process in response to a request from a process request device, includes:

a response time calculation step that calculates a response time for each processing device, based on a time which each processing device needs for the process;

a permissible time calculation step that calculates a permissible time for each item of identification information corresponding to the process request device, based on a time from a start of a request for the process, from the process request device to the processing device, to an interruption of a request for the process;

an acquisition step that acquires a communication time needed for a transmission and reception of information between the process request device and the processing device; and

a calculation step that calculates the information relating to the processing speed, for each processing device, for each item of identification information, based on the communication time acquired by the acquisition step, the response time calculated by the response time calculation step, and the permissible time corresponding to the identification information calculated by the permissible time calculation step.

### BRIEF DESCRIPTION OF THE DRAWINGS

FIG. 1 is a schematic diagram showing an outline of a processing speed calculation system;

FIG. 2 is a time chart showing a flow from a process request start to receiving a process result;

FIG. 3 is a block diagram showing a hardware configuration of a personal computer;

FIG. 4 is an illustration showing a screen image of a withdrawal service;

FIG. 5 is a block diagram showing a hardware configuration of a withdrawal server;

FIG. 6 is an illustration showing a record layout of an account DB;

FIG. 7 is a block diagram showing a hardware configuration of a calculation server;

FIG. 8 is an illustration showing a record layout of a communication time file;

FIG. 9 is an illustration showing a record layout of a response time file;

FIG. 10 is an illustration showing a record layout of a permissible time file;

FIG. 11 is an illustration showing a record layout of an evaluation value file;

FIG. 12 is an illustration showing a display image of an evaluation value;

FIG. 13 is a flowchart showing a communication time calculation procedure;

FIG. 14 is a flowchart showing calculation procedures for a processing time and a response time;

FIG. 15 is a flowchart showing calculation procedures for a waiting time and a permissible time;

FIG. 16 is a flowchart showing an evaluation value calculation procedure;

FIG. 17 is a schematic diagram showing an outline of a processing speed calculation system according to a second embodiment;

FIG. 18 is a schematic diagram showing an outline of a processing speed calculation system according to a third embodiment; and

FIG. 19 is a block diagram showing a configuration of a calculation server according to a fourth embodiment.

### DETAILED DESCRIPTION OF THE EMBODIMENT(S)

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

### First Embodiment

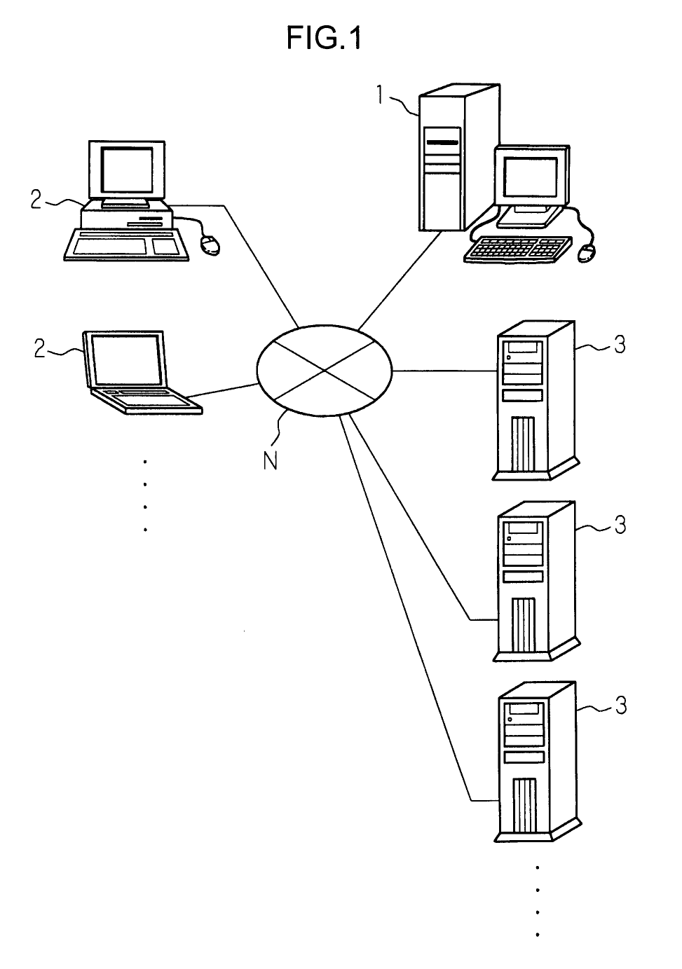

Hereafter, a description will be given of embodiments of the invention, with reference to the drawings. FIG. 1 is a schematic diagram showing an outline of a processing speed calculation system. The processing speed calculation system includes a communication network N, such as an internet, a plurality of process request devices 2, used by users, a calculation device 1 which calculates information relating to a processing speed, and a plurality of processing devices 3, 3, which execute various kinds of process in response to requests from the process request devices 2, 2 . . . . In the embodiment, a description is given of an example in which the processing speed calculation system is applied to an internet banking service. However, apart from the internet banking service too, it is also acceptable that the invention is applied to online shopping on the internet, various kinds of search services, an ATM (Automated Teller Machine) service inside a bank, or the like.

The process request device 2 is, for example, a personal computer used by the user. The process request device 2 carries out a transmission and reception of information between the calculation device 1 and the processing device 3 by means of a protocol using an HTTP (Hyper Text Transfer Protocol) or the like. Hereafter, a description will be given with the process request device 2 as a personal computer 2. The user inputs identification information, such as an account number (hereafter referred to as the account number), and a password for specifying the user into the personal computer 2 and, by logging in after authentication in the processing device 3 or calculation device 1, can receive a provision of various kinds of service.

The processing devices 3, are devices which carry out various kinds of services in internet banking such as, for example, a deposit service, a withdrawal or withdrawal service, a balance inquiry service, a fixed-term deposit service, a foreign currency deposit service, an investment trust service, and a transfer service. As the processing device 3, for example, a server computer or the like is used. Hereafter, a description will be given with the processing device 3 as a server computer 3. The server computers 3 share and execute the services. For example, one server computer 3 executes a process relating to the deposit service, in response to a request from the user's personal computer 2. Another server computer 3 executes a process relating to the withdrawal service, in response to a request from the user's personal computer 2. Hereafter, a description will be given of an example in which each server computer 3 executes a different process, but it is, of course, also acceptable that one server computer 3 executes processes relating to a plurality of services.

The calculation device 1 is a device which calculates information relating to a processing speed for each server computer 3. The calculation device 1 is, for example, a server computer. Hereafter, a description will be given with the calculation device 1 as a calculation server 1.

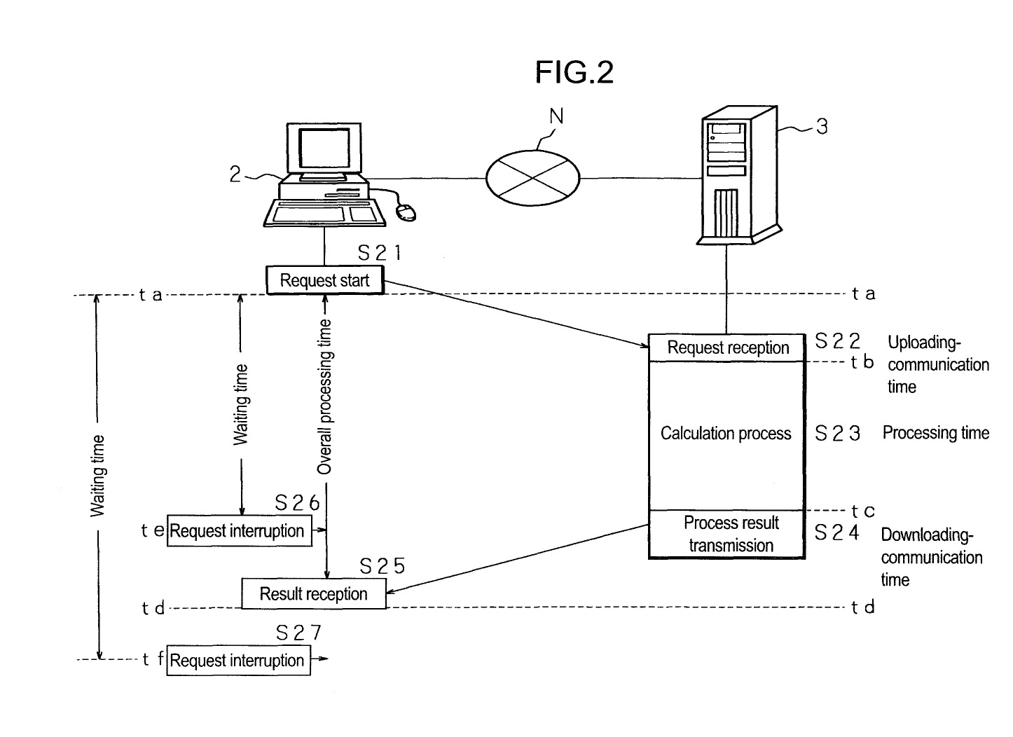

FIG. 2 is a time chart showing a flow from a process request start to receiving a process result. The left side of the time chart shows a process in the user's personal computer 2. The right side of the time chart shows a process in the server computer 3. Also, a vertical direction of the time chart shows an elapsing of time from ta to tf. The user, after logging in, in order for example to cause the server computer 3 which carries out the withdrawal service to carry out a withdrawal process, accesses the server computer 3 using the personal computer 2. The personal computer 2 transmits a signal announcing the process request start to the server computer 3 (step S21). A request start time is taken as ta.

The server computer 3 receives information on the announcement of the request start transmitted from the personal computer 2 at a time tb (step S22). A period ta to tb varies depending on a status of communication between the personal computer 2 and the server computer 3. The period ta to tb is called an uploading-communication time.

The server computer 3 receives the process request, and starts a withdrawal service process (step S23). The withdrawal service process is a process such as, for example, a retrieval of a balance corresponding to the user's account number from an unshown data base. This process varies depending on process details, a number of accesses from other personal computers 2, and the like. A finishing time of the withdrawal service process is taken as a time tc. Hereafter, a period tb to tc from the process start to the process finish will be called a processing time. After a finish of a calculation process, the server computer 3 transmits the process result, based on a withdrawal process result, to the personal computer 2 (step S24).

The personal computer 2 receives the result transmitted from the server computer 3 (step S25). Herein, a transmission time of the process result in the server computer 3 is taken as tc. Also, a result reception time in the personal computer 2 is taken as td. A period tc to td varies depending on the status of communication between the personal computer 2 and the server computer 3. Hereafter, the period tc to td will be referred to as a downloading-communication time. A communication time which is a sum of the uploading-communication time and the downloading-communication time can be acquired by transmitting a signal relating to a predetermined command, for example, a ping command, from the personal computer 2 to the server computer 3. Specifically, the communication time can be obtained by calculating a difference between a time of transmitting an echo request packet, based on an input of the ping command from the personal computer 2, and a time of receiving an echo response packet from the server computer 3 in the personal computer 2. Alternatively, it is also acceptable to acquire the communication time by transmitting the signal relating to the ping command from the server computer 3 to the personal computer 2.

The user's personal computer 2 finishes the process for the predetermined service in this way. The series of times ta to td is referred to as an overall processing time. It being possible that a large amount of time is spent on the processing in a case of, for example, a server computer 3 which carries out the investment trust service, the overall processing time, depending on the service, that is to say, depending on the server computer 3, varies further depending on the status of communication between the personal computer 2 and the server computer 3.

Also, depending on the user, there exist those who can wait a long time, and there exist those who can only wait a short time. In the event that a signal announcing an interruption of the request is transmitted from the personal computer 2 before an overall processing time in progress is completed (step S26), the server computer 3 interrupts the process. Conversely, in a case of a user who can easily wait a time until the process is finished, it is supposed that information indicating a request interruption is transmitted at the time tf, after the time td, after the overall processing time is finished. In this case, as the process in the server computer 3 is completed, the process is not interrupted. Hereafter, a period indicated by times ta to te or by ta to tf will be referred to as a waiting time. In this way, the waiting time varies depending on the user's personality.

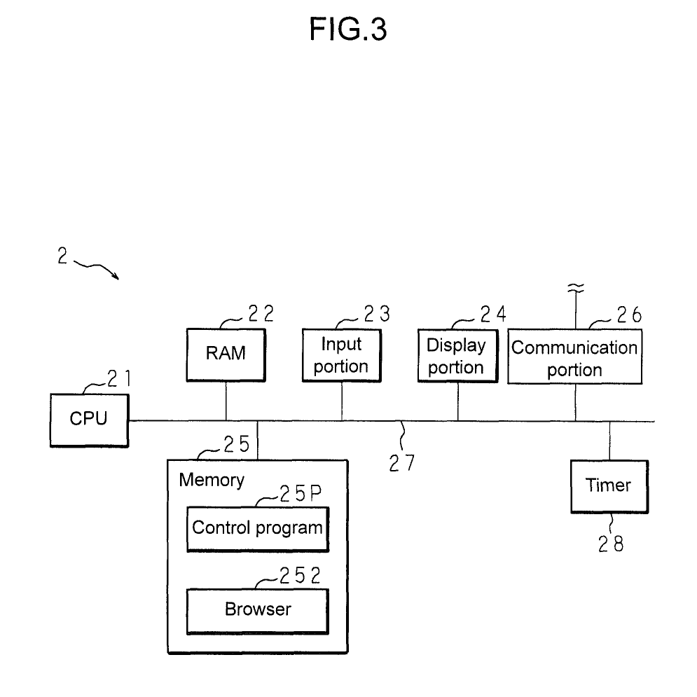

FIG. 3 is a block diagram showing a hardware configuration of the personal computer 2. The personal computer 2 includes a CPU (Central Processing Unit) 21 as a controller, an RAM (Random Access Memory) 22, an input portion 23, a display portion 24, a communication portion 26, a timer 28 and a memory 25. The CPU 21 is connected to each portion of the hardware of the personal computer 2 via a bus 27. The CPU 21 controls each portion of the hardware of the personal computer 2. The CPU 21 executes various software related functions in accordance with a control program 25P stored in the memory 25 of the personal computer 2.

The display portion 24 is, for example, a liquid crystal display. The input portion 23 is, for example, a keyboard and a mouse. The communication portion 26 is, for example, a modem or a LAN (Local Area Network) card. The timer 28 transmits information on a current date and time to the CPU 21. The memory 25 is, for example, a hard disc. The heretofore described control program 25P, and a browser 252, such as Internet Explorer (registered trademark), are stored in the memory 25.

The user, when starting the internet banking service, starts up the browser 252 by operating the input portion 23, and accesses the server computer 3. The user inputs the account number and password via the input portion 23. The CPU 21 transmits the input account number and password to the server computer 3 via the communication portion 26. The server computer 3 carries out an authentication by comparing the transmitted account number and password with an account number and password stored in advance. In the event that the authentication is successful, the server computer 3 reads screen data, described in an HTML, which execute the service, and transmits the screen data read to the personal computer 2. The browser 252 of the personal computer 2 displays the screen data transmitted from the server computer 3.

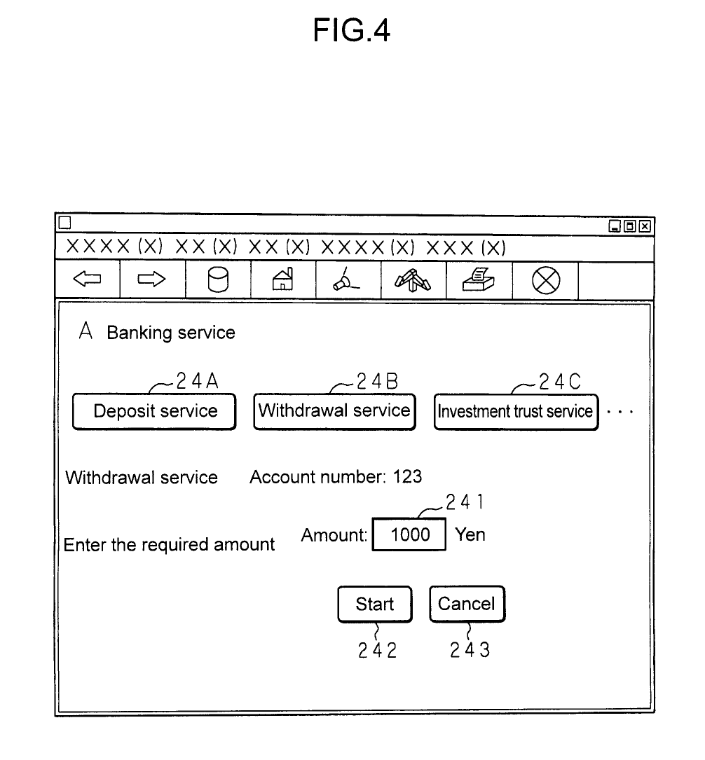

FIG. 4 is an illustration showing a screen image of the withdrawal service. Hereafter, in order to simplify a description, a description will be given of an example in which the deposit service, the withdrawal service and the investment trust service exist as the services, and the user executes, from among these services, the withdrawal service. Also, hereafter, the server computer 3 which executes the process relating to the deposit service is called a deposit server 3A, the server computer 3 which executes the process relating to the withdrawal service is called a withdrawal server 3B, and the server computer 3 which executes a process relating to the investment trust service is called an investment trust server 3C. As shown in FIG. 4, a deposit service button 24A, a withdrawal service button 24B and an investment trust service button 24C, for executing the various kinds of service, are displayed aligned in a horizontal direction.

Hyperlinks, for accessing the deposit server 3A, the withdrawal server 3B or the investment trust server 3C, are described in the deposit service button 24A, the withdrawal service button 24B and the investment trust service button 24C. In the example of FIG. 4, on the withdrawal service button 24B being clicked by means of the input portion 23, an input screen for inputting a withdrawal amount and the like is transmitted from the withdrawal server 3B, and the input screen for inputting the withdrawal amount and the like is displayed on the browser 252. A user's account number “123” after logging in is displayed on the browser 252. The user inputs an amount to be withdrawn in an amount box 241 by means of the input portion 23. In the example of FIG. 4, “1000” yen has been input in the amount box 241.

A start button 242 and a cancel button 243 are disposed side by side in a lower portion of the browser 252. The hyperlink is described in both the start button 242 and the cancel button 243. After the inputting of the amount in the amount box 241, in the event that the start button 242 is clicked via the input portion 23, the CPU 21 refers to the hyperlink described in the start button 242, and transmits a request start signal, the account number and the withdrawal amount to the withdrawal server 3B. By this means, a process in the withdrawal server 3B is executed. In this case, the CPU 21, based on date and time information transmitted from the timer 28, stores a request start date and time, at which the request start signal is transmitted, in the RAM 22. In the event that, during this processing period, the cancel button 243 is clicked via the input portion 23, the CPU 21 refers to the hyperlink described in the cancel button 243, and transmits a request interruption signal and the account number to the withdrawal server 3B. In this case, the withdrawal process in the withdrawal server 3B is interrupted.

Furthermore, the CPU 21, based on the date and time information transmitted from the timer 28, stores a request interruption date and time, at which the request interruption signal is transmitted, in the RAM 22. The CPU 21 reads the request interruption date and time and the request start date and time from the RAM 22, and calculates a difference. Then, the CPU 21, taking this difference as a waiting time, transmits it, along with the request interruption date and time, a service name, and the account number, to the calculation server 1.

The CPU 21 of the personal computer 2, in accordance with an instruction from the control program 25P, after logging in, regularly transmits signals relating to the ping command to the deposit server 3A, the withdrawal server 3B and the investment trust server 3C. The CPU 21 calculates the communication time based on a difference between date and time information transmitted from the timer 28 when transmitting the echo request packet, which is a signal based on the ping command, and date and time information transmitted from the timer 28 when receiving the echo response packet returned from the deposit server 3A, the withdrawal server 3B or the investment trust server 3C, in response to the ping command. It is preferable that a timing at which the signals relating to the ping command are transmitted is every other minute after logging in, or the like. Communication times calculated in this way are transmitted sequentially to the calculation server 1.

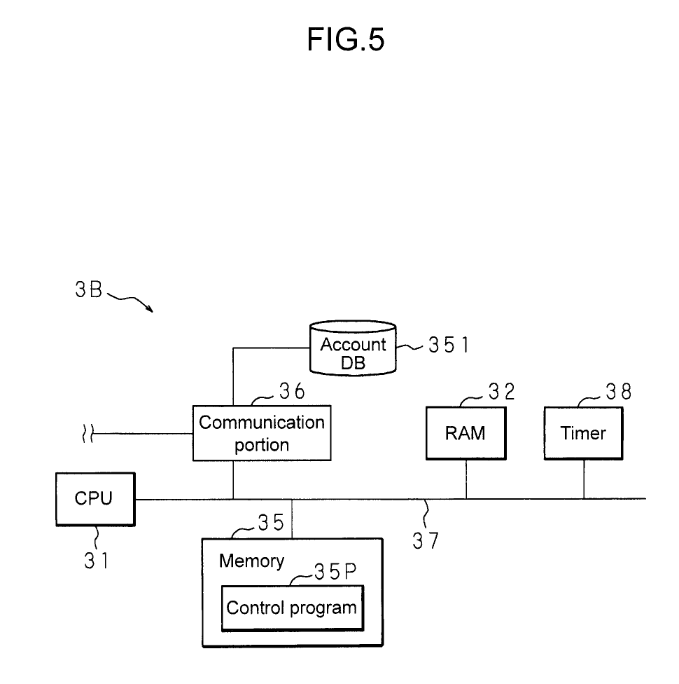

FIG. 5 is a block diagram showing a hardware configuration of the withdrawal server 3B. The withdrawal server 3B includes a CPU 31 as a controller, an RAM 32, a communication portion 36, a timer 38, a memory 35, and an account data base (hereafter referred to as an account DB) 351. The CPU 31 is connected to each portion of the hardware of the withdrawal server 3B via a bus 37. The CPU 31 controls each portion of the hardware of the withdrawal server 3B. The CPU 31 executes various software related functions in accordance with a control program 35P stored in the memory 35.

The communication portion 36 is, for example, a gateway which performs a function as a firewall. The timer 38 transmits the information on the current date and time to the CPU 31. The memory 35 is, for example, the hard disc. The heretofore described control program 35P is stored in the memory 35. The CPU 31, in accordance with the control program 35P, executes various kinds of process, such as the authentication of the user and the withdrawal process. The account DB 351 is also connected to the communication portion 36. The CPU 31, by interacting using an SQL (Structured Query Language) in a schema to which is correlated a key of a field of the account DB 351, executes processes such as a storage of, or search for, necessary information.

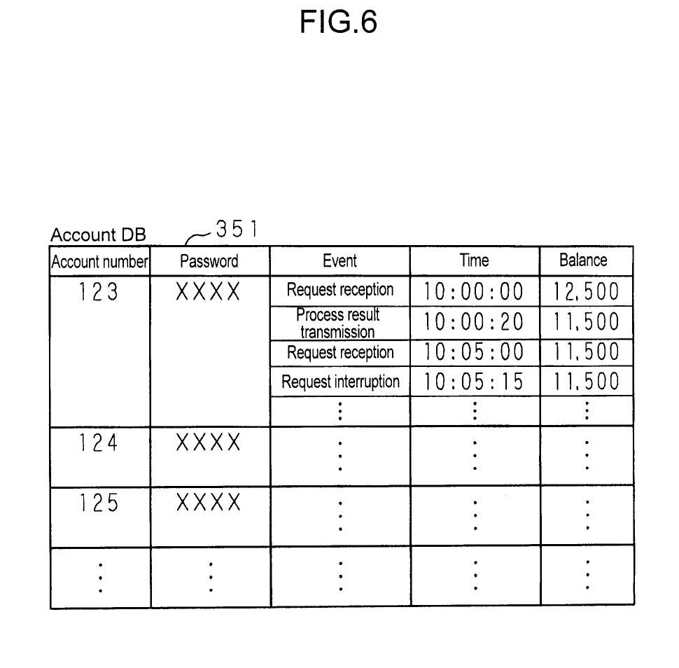

FIG. 6 is an illustration showing a record layout of the account DB 351. The account DB 351 includes an account number field, a password field, an event field, a time field and a balance field. A storage format of data of the account DB 351, being no more than one example, is not limited to this. The account number for specifying the user is recorded in the account number field. Also, the password for carrying out the authentication of the user is recorded, correlated to the account number, in the password field.

Events based on signals transmitted from the personal computer 2 are recorded, correlated to the account number, in the event field. Also, date and time information on times at which the events occur is recorded, correlated to the account number and the events, in the time field. For example, a request reception, which is one of the events, indicates a fact that the start button 242 shown in FIG. 4 has been clicked in the personal computer 2, and the request start signal for carrying out the 1000 yen withdrawal process has been received. For example, the request reception indicates that the request reception event has occurred at 10:00:00. In the event of receiving the request start signal, the CPU 31 of the withdrawal server 3B, as well as storing an event relating to the request reception in the event field of the account DB 351, records date and time information based on a transmission from the timer 38 in the time field.

A process result transmission, which is one of the events, indicates a fact that a series of processes relating to the withdrawal process in the CPU 31 is finished, and the process result has been transmitted. For example, the process result transmission indicates that the process result transmission event has occurred at 10:00:20. The balance is recorded, correlated to the account number, the event and the time, in the balance field. In the embodiment, the balance is recorded as 12500 yen at the time of the request reception event. The CPU 31, in response to the 1000 yen withdrawal process, carries out a subtraction process. At the time of the process result transmission event, a balance which has been reduced by 1000 yen to 11500 yen is recorded in the balance field. In the event of transmitting the process result, the CPU 31 of the withdrawal server 3B, as well as storing an event relating to the process result transmission in the event field of the account DB 351, records date and time information based on a transmission from the timer 38 in the time field.

Furthermore, as shown in FIG. 6, it can be understood that the request reception, which is one of the events, has occurred again at 10:05:00. A request interruption event indicates that the cancel button 243 shown in FIG. 4 has been clicked, by means of the input portion 23, partway through the withdrawal process, and that the CPU 21 of the personal computer 2 has interrupted the request to the withdrawal server 3B relating to the withdrawal. The request interruption event has occurred (at 10:05:15) 15 seconds after the request reception (10:05:00). The CPU 31 of the withdrawal server 3B, in accordance with the cancel button 243 being operated, receives the request interruption signal transmitted by the CPU 21 of the personal computer 2. In an example described in the time field, a description of a month and day is omitted.

In the event of receiving the request interruption signal, the CPU 31, as well as interrupting the process relating to the withdrawal, records an event relating to the request interruption in the event field of the account DB 351. Then, the CPU 31 records date and time information based on a transmission from the timer 38 in the time field. As the withdrawal process has been interrupted, storage contents of the balance field, not changing, remain, in the embodiment, at 11500 yen. The CPU 31 also records events resulting from actions of other users having other account numbers in the account DB 351 in the same way.

Every time the process result transmission event finishes, the CPU 31 of the withdrawal server 3B reads the time corresponding to the process result transmission event and the time corresponding to the request reception event from the account DB 351, and transmits a processing time, which is a difference between them, to the calculation server 1, along with the account number, and information on the date and time at which the process result transmission event has occurred (hereafter, a process result transmission date and time).

Also, every time the request interruption event finishes, the CPU 31 of the withdrawal server 3B reads the time corresponding to the request interruption event and the time corresponding to the request reception event from the account DB 351, and transmits a waiting time, which is a difference between them, to the calculation server 1, along with the account number, and information on the date and time at which the request interruption event has occurred (hereafter, a request interruption date and time). By this means, every time the process finishes and every time the request is interrupted, the processing time and the waiting time are added to the calculation server 1. Although a description will be given of an aspect in which a calculation of the communication time using the ping command is executed by the personal computer 2, and the calculated communication time transmitted to the calculation server 1, it is also acceptable to arrange in such a way that the relevant process is carried out by the withdrawal server 3B, and the calculated communication time transmitted to the calculation server 1. For example, it is also acceptable to arrange in such a way that, after the logging in using the user's account number, the CPU 31 of the withdrawal server 3B transmits an echo request packet, based on the ping command, to the personal computer 2, receives an echo response packet from the personal computer 2, and calculates the communication time based on a difference between a transmission time and a reception time. Then, the CPU 31 of the withdrawal server 3B transmits the calculated communication time, correlated to the account number, to the calculation server 1.

Also, it is also acceptable to arrange in such a way that the waiting time, apart from being transmitted, correlated to the account number, from the withdrawal server 3B to the calculation server 1, as heretofore described, is transmitted from the personal computer 2 to the calculation server 1. In FIG. 3, the CPU 21 of the personal computer 2, based on the transmission from the timer 28, stores the request start time, which is the time at which the start button 242 is clicked via the input portion 23, in the RAM 22. In the event that the cancel button 243 is clicked via the input portion 23, the CPU 21 makes a time at which that occurs a request interruption time and, based on a transmission from the timer 28, stores it in the RAM 22. Then, the CPU 21 subtracts the request start time from the request interruption time stored in the RAM 22 to calculate the waiting time. The CPU 21 transmits the calculated waiting time, the account number, the name of the service being provided, and the request interruption date and time, which is the request interruption time stored in the RAM 22 with information on the month and day added, to the calculation server 1. In this way, the waiting time is transmitted by either one of the personal computer 2 or the withdrawal server 3B. Hereafter, a description will be given assuming that the waiting time is transmitted from the personal computer 2.

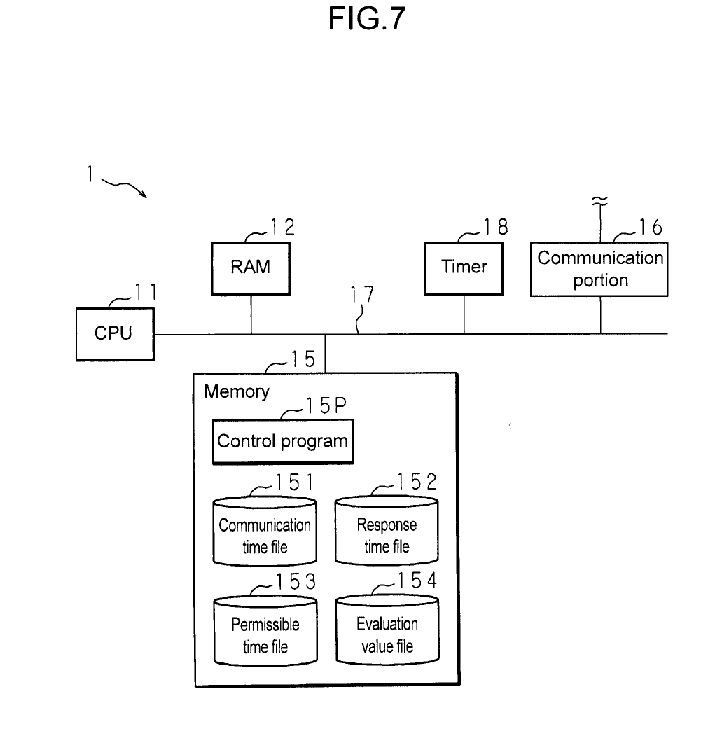

FIG. 7 is a block diagram showing a hardware configuration of the calculation server 1. The calculation server 1 includes a CPU 11 as a controller, an RAM 12, a communication portion 16, a timer 18 and a memory 15. The CPU 11 is connected to each portion of the hardware of the calculation server 1 via a bus 17. The CPU 11 controls each portion of the hardware of the calculation server 1. The CPU 11 executes various software related functions in accordance with a control program 15P stored in the memory 15.

The communication portion 16 is, for example, a gateway which performs a function as a firewall. The communication portion 16 carries out a transmission and reception of information between the deposit server 3A, withdrawal server 3B and investment trust server 3C, and the personal computers 2, 2 . . . of each user. The timer 18 transmits the information on the current date and time to the CPU 11. The memory 15 is, for example, the hard disc. The heretofore described control program 15P, a communication time file 151, a response time file 152, a permissible time file 153, and an evaluation value file 154 are stored in the memory 15.

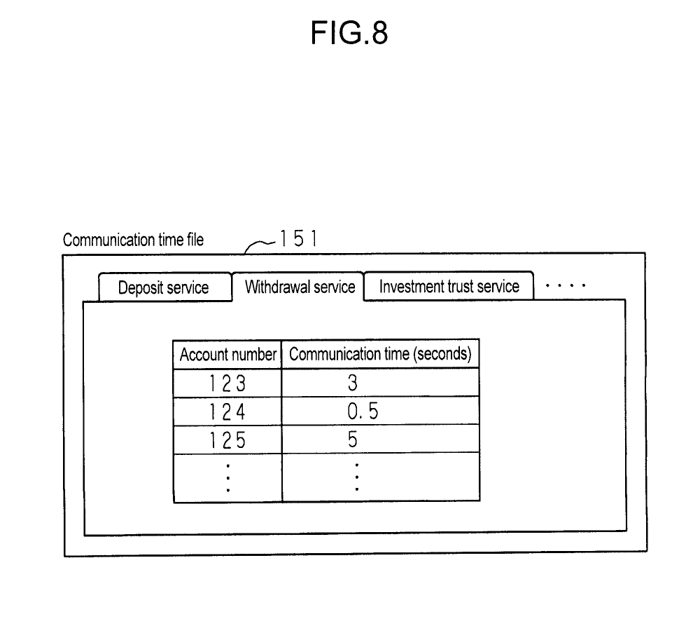

FIG. 8 is an illustration showing a record layout of the communication time file 151. The communication time is recorded, correlated to the account number, for individual services, such as the deposit service, the withdrawal service, and the investment trust service, in the communication time file 151. More specifically, the communication time file 151 includes an account number field and a communication time field. The account number is recorded in the account number field. The communication time transmitted from each user's personal computer 2 is recorded, correlated to the account number, in the communication time field. As heretofore described, every time a communication time is transmitted, correlated to the account number, from the personal computer 2, the CPU 11 updates contents of the communication time. In the example in the figure, a communication time between the personal computer 2 of the user with the account number 123, and the withdrawal server 3B, is recorded as three seconds at the present moment. As heretofore described, it is also acceptable that the communication time recorded in the communication time file 151 is the communication time transmitted from the withdrawal server 3B.

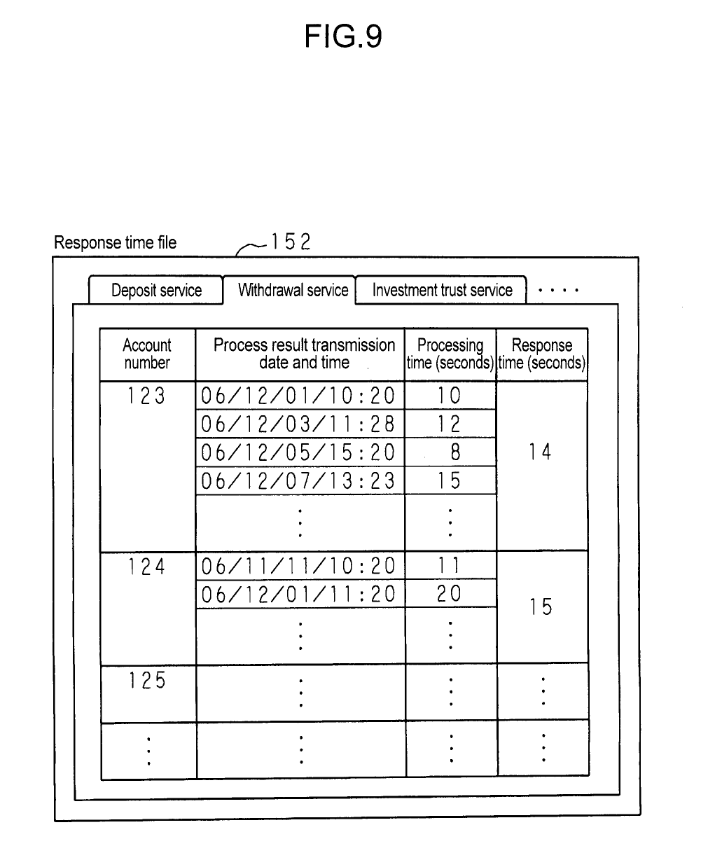

FIG. 9 is an illustration showing a record layout of the response time file 152. The response time file 152 is configured to include an account number field, a process result transmission date and time field, a processing time field, and a response time field for each service, such as the deposit service, the withdrawal service, and the investment trust service. The account number is recorded in the account number field. Also, the process result transmission date and time transmitted, correlated to the account number, along with the account number from the withdrawal server 3B, in response to the process result transmission event, is recorded in the process result transmission date and time field. That is, as heretofore described, every time the process result transmission event finishes, the CPU 31 of the withdrawal server 3B reads the time corresponding to the process result transmission event and the time corresponding to the request reception event from the account DB 351, and transmits the processing time, which is the difference between them, to the calculation server 1, along with the account number, and the process result transmission date and time.

The CPU 11 of the calculation server 1, as well as recording the transmitted process result transmission date and time, correlated to the account number, in the process result transmission date and time field, records the simultaneously transmitted processing time in the processing time field. For example, in response to a request from the user with the account number 123, the CPU 31 of the withdrawal server 3B has transmitted a process result to the personal computer 2 at 10:20 on Dec. 1, 2006, and a processing time needed for the process is recorded as 10 seconds. Also, the user with the account number 123 has also used the withdrawal service two days later, at 11:28 on Dec. 3, 2006, in which case, the process needing a little more time, the processing time is recorded as 12 seconds. The CPU 11, in this way, records the processing times as time-series data in the response time file 152.

A response time calculated based on the processing time is recorded, for each process service and account number, in the response time field. A response time relating to the account number is, for example, an average value based on a history of processing times recorded in the processing time field of the account number. For example, in the withdrawal service, a response time of 14 seconds is recorded as the average value for the user with the account number 123, while a response time of 15 seconds is recorded for a user with an account number 124. Every time the processing time is transmitted from the withdrawal server 3B, the CPU 11 calculates an average value of, for example, 10 days' worth of processing times, and records it in the response time field. In the event that no history has been accumulated, the CPU 11 uses an appropriate value, or a response time relating to another account number, stored in the memory 15.

The calculation of the response time being no more than one example, it is also acceptable that it is another calculation method, as long as it is an aspect using the history of processing times. For example, it is also acceptable to employ a processing time with the newest history as the response time. Furthermore, it is also acceptable to multiply a predetermined number of days' worth of processing times by coefficients, of which weights become greater the newer the history becomes, to obtain an average value thereof. Specifically, the CPU 11 reads coefficients, stored in the memory 15, relating to weights which become incrementally smaller. The CPU 11 multiplies the coefficients relating to the weights, sequentially from the largest, with the predetermined number of days' worth of processing times, sequentially from that with the newest history. Then, it is possible to obtain the response time by calculating a sum of a value after the multiplication, and dividing it by the predetermined number of days. Also, in the embodiment, the response time is obtained for each individual account number, but it is also acceptable to make the response time an average value of a predetermined number of days' worth of processing times of all the account numbers. Hereafter, a description will be given assuming that a response time for each service is an average value of an immediately preceding ten days' worth of processing times relating to all the account numbers for each service.

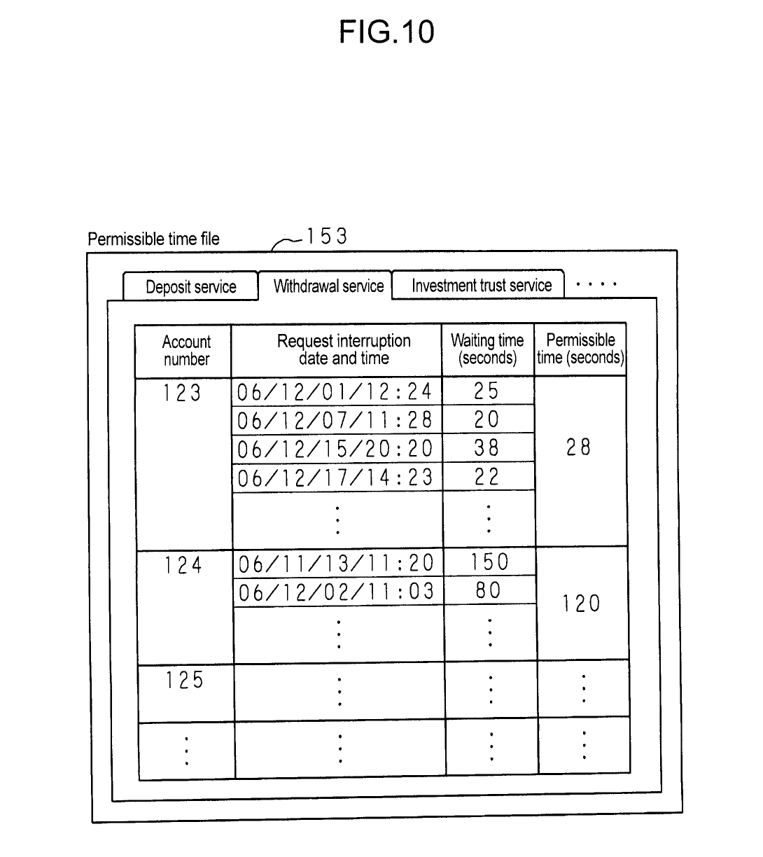

FIG. 10 is an illustration showing a record layout of the permissible time file 153. The permissible time file 153 includes an account number field, a request interruption date and time field, a waiting time field, and a permissible time field for each service, such as the deposit service, the withdrawal service, and the investment trust service. The account number is recorded in the account number field. Also, the request interruption date and time transmitted, correlated to the account number, along with the account number, the service name and the waiting time, from the personal computer 2, in response to the request interruption, is recorded in the request interruption date and time field. A waiting time for each request interruption date and time transmitted from the personal computer 2 is recorded in the waiting time field.

In the event that the waiting time is transmitted from the withdrawal server 3B, the account number is recorded in the account number field, and the request interruption date and time transmitted, correlated to the account number, along with the account number, from the withdrawal server 3B, in response to the request interruption event, is recorded in the request interruption date and time field. That is, as heretofore described, every time the request interruption event finishes, the CPU 31 of the withdrawal server 3 reads the time corresponding to the request interruption event and the time corresponding to the request reception event from the account DB 351, and transmits the waiting time, which is the difference between them, to the calculation server 1, along with the account number, and the request interruption date and time at which the request interruption event has occurred.

The CPU 11 of the calculation server 1, as well as recording the request interruption date and time transmitted, correlated to the account number, from the personal computer 2, in the request interruption date and time field, records the simultaneously transmitted waiting time in the waiting time field. For example, the user with the account number 123, unable to wait for the finish of the process, has interrupted the process at 12:24 on Dec. 1, 2006, after the withdrawal process request start. The waiting time in this case is 25 seconds. Also, the user has also interrupted the process six days later, at 11:28 on Dec. 7, 2006, in which case the waiting time is 20 seconds.

The waiting times are recorded for each individual account number relating to the users. For example, the user with the account number 124 has interrupted the process at 11:20 on Nov. 13, 2006, and has interrupted the process at 11:03 on Dec. 2, 2006, with the waiting times recorded respectively as 150 seconds and 80 seconds. In the embodiment, it can be understood that the user with the account number 124 shows a tendency to wait longer for the process.

The CPU 11, in this way, records the waiting times as time-series data in the permissible time file 153. A permissible time calculated based on the waiting time is recorded, for each process service and account number, in the permissible time field. A permissible time relating to the account number is, for example, an average value based on a history of waiting times recorded in the waiting time field of the account number. For example, in the withdrawal service, a permissible time of 28 seconds is recorded as the average value for the user with the account number 123, while a permissible time of 120 seconds is recorded for the user with the account number 124. Every time the waiting time is transmitted from the withdrawal server 3B, the CPU 11 calculates an average value of, for example, the immediately preceding 10 days' worth of waiting times, and records it in the permissible time field. In the event that no history has been accumulated, the CPU 11 uses an appropriate value, or a permissible time relating to another account number, stored in the memory 15.

The calculation of the permissible time being no more than one example, it is also acceptable that it is another calculation method, as long as it is an aspect using the history of waiting times. For example, it is also acceptable to employ a waiting time with the newest history as the permissible time. Furthermore, it is also acceptable to multiply a predetermined number of days' worth of waiting times by coefficients, of which weights become greater the newer the history becomes, to obtain an average value thereof. Specifically, the CPU 11 reads coefficients, stored in the memory 15, relating to weights which become incrementally smaller. The CPU 11 multiplies the coefficients relating to the weights, sequentially from the largest, with the predetermined number of days' worth of waiting times, sequentially from that with the newest history. Then, it is possible to obtain the permissible time by calculating a sum of values after the multiplication, and dividing it by the predetermined number of days.

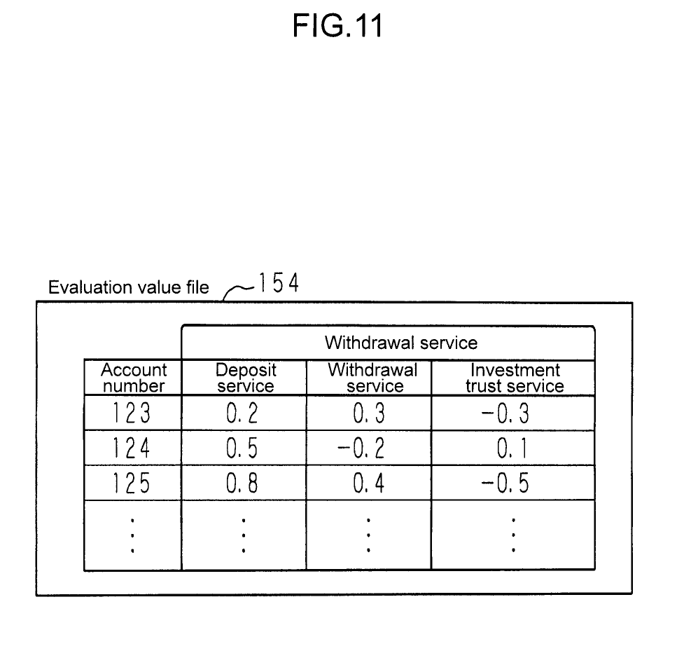

FIG. 11 is an illustration showing a record layout of the evaluation value file 154. Information relating to the processing speed of each server computer 3 is recorded, correlated to the account number, as an evaluation value in the evaluation file 154. The evaluation value, which is the information relating to the processing speed, is obtained, for example, according to a following calculation procedure. The CPU 11 reads the permissible time recorded in the permissible time file 153 for each individual account number. For example, the permissible time for the withdrawal service for the account number 123 is 28 seconds. Then, the CPU 11 reads the response time relating to the withdrawal service from the response time file 152. For example, it is taken that the response time of the withdrawal service is 14 seconds.

Furthermore, the CPU 11 reads the communication time, corresponding to the account number, recorded in the communication time file 151. For example, the communication time for the withdrawal service for the account number 123 is three seconds. The CPU 11 obtains the evaluation value by subtracting a sum of the read response time and communication time from the read permissible time, and dividing the reduced value by the read permissible time. In the heretofore described example, a subtraction value of 11 seconds is obtained by subtracting a sum, 17 seconds, of the response time of 14 seconds and the communication time of 3 seconds from the permissible time of 28 seconds. By dividing the subtraction value of 11 seconds by the permissible time of 28 seconds, an evaluation value of approximately 0.39 is obtained. The CPU 11 carries out the process of calculating the evaluation value for each account number for each individual service, that is, for each of the deposit service 3A, the withdrawal service 3B, and the investment trust service 3C, and records the evaluation value, correlated to the service and the account number, in the evaluation value file 154.

The evaluation value being normalized based on a ratio between the subtraction value and the permissible time, in the event of it being a positive value, the larger the value, the better a service provision environment for the user. Conversely, in the event of it being a negative value, it can be said that the smaller the value, the more the service provision environment worsens due to congestion. It is also acceptable that the evaluation value calculation method is another calculation method, as long as it is an aspect using the communication time, the response time, and the permissible time. For example, it is also acceptable to simply take as the evaluation value the value of the sum of the communication time and response time subtracted from the permissible time. Apart from this, it is also acceptable to take as the evaluation value the ratio between the permissible time and the sum of the communication time and response time. Also, in the event that the communication time is short in comparison with the response time, it is not essential to include it in the calculation of the evaluation value. For example, it is also acceptable to divide a subtraction value of the response time subtracted from the permissible time by the permissible time, and make it the evaluation value. Furthermore, it is also acceptable to make a value of the response time subtracted from the permissible time the evaluation value. In this case, as a communication load of a transmission of a signal relating to the ping command, and a transmission and reception of the communication time, is reduced, it is possible to achieve an acceleration of the process. In this way, in the embodiment, a description is given of an aspect obtaining a more detailed evaluation value, considering a real time communication time between the personal computer 2 and the server computer 3, but, depending on conditions, it is not inevitably necessary to use the communication time.

The user, in the event of using the internet banking service again at a later date, logs in by inputting the account number. The CPU 21 of the personal computer 2 transmits the signal relating to the ping command to the deposit server 3A, the withdrawal server 3B, and the investment trust server 3C, and transmits the communication time thus obtained to the calculation server 1. By this means, the communication time file 151 of the calculation server 1 is updated. The CPU 11 of the calculation server 1, by means of the heretofore described process, based on the communication time of the updated communication time file 151 relating to the relevant account number, the response time for each service recorded in the response time file 152, and the permissible time relating to the account number, for each service, recorded in the permissible time file 153, calculates the evaluation value, for each service, relating to the account number, and records the evaluation value calculated for each service, correlated to the account number, in the evaluation file 154.

The CPU 11 of the calculation server 1 transmits the evaluation value, calculated for each service, relating to the account number to the personal computer 2. The CPU 21 of the personal computer 2 displays the transmitted evaluation value for each service in the display portion 24. Also, it is also acceptable, rather than transmitting the evaluation value directly to the personal computer 2, to first transmit it to the server computer 3 and, after compiling an HTML document in order that the evaluation value is clearly visible, transmit it from the server computer 3 to the personal computer 2. Hereafter, a description will be given of an aspect in which the evaluation value is transmitted from the calculation server 1, via the withdrawal server 3B, to the personal computer 2.

The CPU 11 of the calculation server 1 transmits the evaluation value, calculated for each service, to the withdrawal server 3B. The CPU 31 of the withdrawal server 3B stores the transmitted evaluation value for each service in the RAM 32. Then, the CPU 31 writes the evaluation value for each service in an HTML document prepared in advance. The CPU 31 transmits the HTML document in which the evaluation value for each service is described to the personal computer 2. The CPU 21 of the personal computer 2 displays the HTML document on the browser.

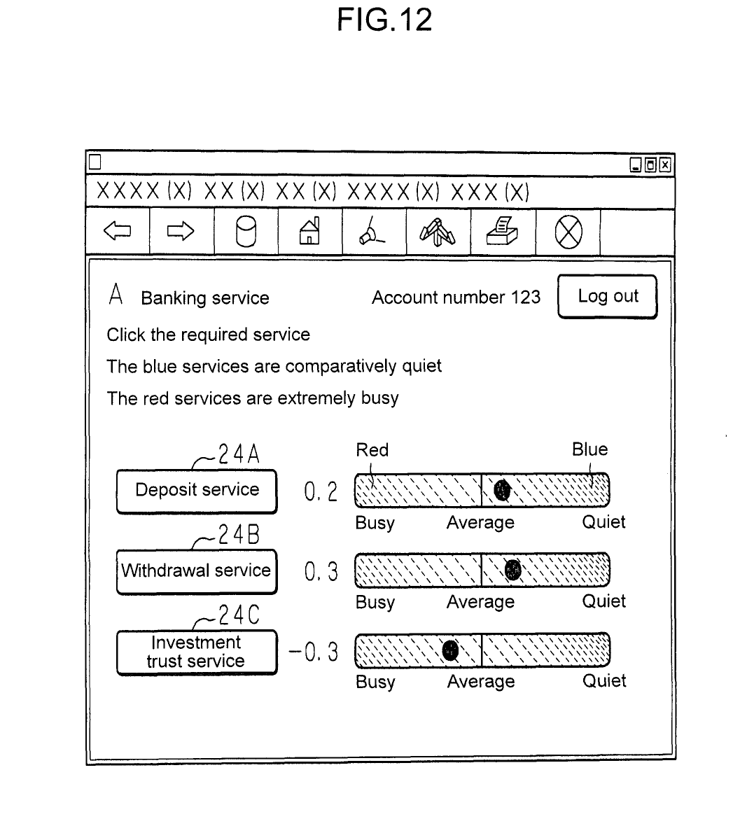

FIG. 12 is an illustration showing a display image of the evaluation value. As shown in FIG. 12, each service is displayed as a scale, in order that the evaluation value and a size of the evaluation value can be visually perceived. In the scale, a central portion is displayed as normal, a right side is displayed as good, blue, or the like, and a left side is described as congested, red, or the like. In the embodiment, an evaluation value of the deposit service is 0.2, an evaluation value of the withdrawal service is better than that of the deposit service at 0.3, and an evaluation value of the investment trust service is an undesirable negative value of −0.3. In the HTML document, in the event that the evaluation value is a positive value, it is described in such a way that the larger it is, the farther to the right side of the scale a • mark is displayed and, in the event that the evaluation value is a negative value, it is described in such a way that the smaller it is, the farther to the left side of the scale the • mark is displayed. Also, in order that it is possible to judge instantly by means of a color, a description is done whereby the blue color, or the like, is painted in such a way that a density becomes gradually higher from the center of the scale to the right while, conversely, a description is done whereby the red color, or the like, is painted in such a way that a density becomes gradually higher from the center of the scale to the left.

In this case, the user with the account number 123 can judge that it is better to carry out the withdrawal service first, and postpone the investment trust service. On the browser, the deposit service button 24A, the withdrawal service button 24B, and the investment trust service button 24C are displayed along with hyperlinks for moving to a process start page of the deposit server 3A, the withdrawal server 3B, and the investment trust server 3C. Herein, in the event that the user clicks the withdrawal service button 24B via the input portion 23, the screen shown in FIG. 4 is displayed, and the withdrawal process is started. In the same way, in the event that the deposit service button 24A is clicked, a connection with the deposit server 3A is established, and a screen starting the deposit service is displayed on the browser. Likewise, in the event that the investment trust service button 24C is clicked, a connection with the investment trust server 3C is established, and a screen starting the investment trust service is displayed on the browser.

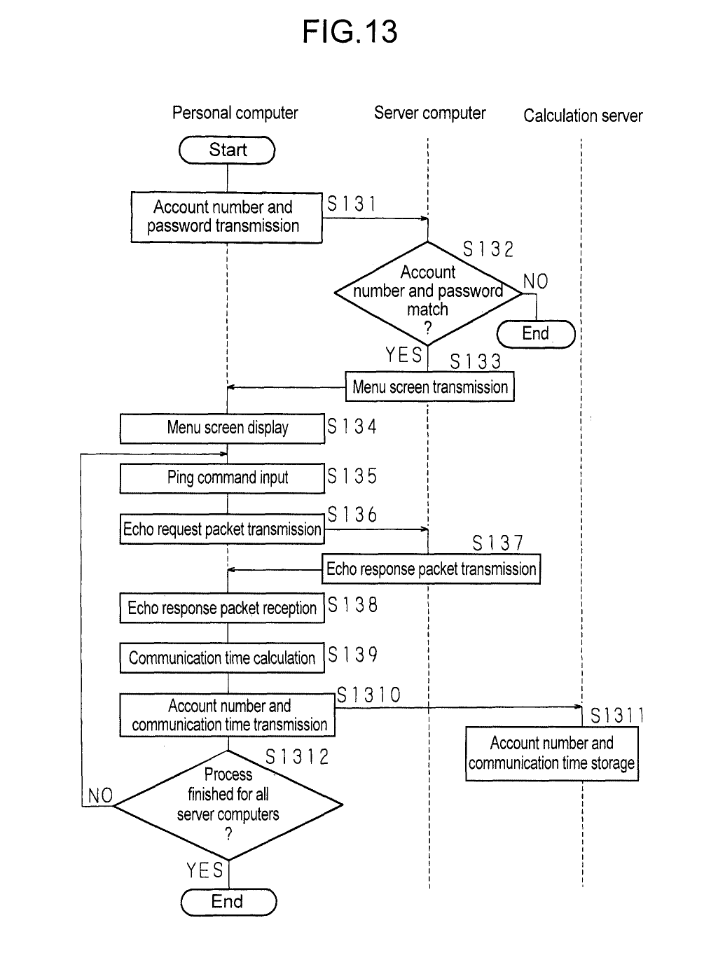

FIG. 13 is a flowchart showing a communication time calculation procedure. The user, after establishing communication between the personal computer 2 and the server computer 3 (the withdrawal server 3B), inputs the account number and password, via the input portion 23, in order to log into the service. The CPU 21 receives the input account number and password, and transmits them to the server computer 3 (step S131). The CPU 31 of the server computer 3 determines whether or not the transmitted account number and password match the account number and password recorded in the account DB 351 (step S132).

If it is determined that the account numbers and passwords do not match (No in step S132), the CPU 31 of the server computer 3, taking it to be an illicit access, finishes the process. Conversely, if it is determined that the account numbers and passwords match (Yes in step S132), the CPU 31 reads a menu screen indicating that the logging in has been successful from the memory 35, and transmits the read menu screen to the personal computer 2 (step S133). The CPU 21 of the personal computer 2 displays the transmitted menu screen on the browser 252 (step S134).

The CPU 21, in accordance with an instruction from the control program 25P, inputs the ping command with an IP (Internet Protocol) address of the server computer 3 as a destination (step S135). Along with the input of the ping command, the CPU 21 transmits the echo request packet to the server computer 3 (step S136). The CPU 21 stores the information on the date and time at which the echo request packet is transmitted, based on the transmission from the timer 28, in the RAM 22. The CPU 31 of the server computer 3 receives the echo request packet, and transmits the echo response packet to the personal computer 2 (step S137).

The CPU 21 of the personal computer 2 receives the echo response packet transmitted from the server computer 3 (step S138). The CPU 21 stores the information on the date and time at which the echo response packet is received, based on the transmission from the timer 28, in the RAM 22. The CPU 21 reads the date and time information relating to the echo request packet transmission time, and the date and time information relating to the echo response packet reception time, from the RAM 22 and, by taking the difference, calculates the communication time (step S139). The CPU 21 transmits the account number and communication time to the calculation server 1, along with a service name or IP address for specifying the server computer 3 (step S1310).

The calculation server 1 receives the transmitted account number and communication time, as well as the service name or IP address for specifying the server computer 3. Then, the CPU 11 of the calculation server 1 records the communication time corresponding to the received service and account number in the communication time file 151, as shown in FIG. 8 (step S1311). By this means, it is possible to acquire the communication time for each individual service and account number. The CPU 21 of the personal computer 2 determines whether or not the above processes are finished for all the server computers 3 (step S1312). That is, in the embodiment, three server computers 3, the withdrawal server 3B, the deposit server 3A, and the investment trust server 3C existing, the CPU 21 determines whether or not the calculation of the communication time is finished for all of these server computers 3. If it is determined that the processes are not finished for all the server computers 3 (No in step S1312), the CPU 21 shifts to step S135, and carries out the process of inputting the ping command with a different IP address as the destination.

Meanwhile, if it is determined that the processes are finished for all the server computers 3 (Yes in step S1312), the CPU 21 finishes the series of processes. It is also acceptable to arrange in such a way that the execution of the processes of steps S135 to S1312 is repeated regularly, for example, every 10 seconds, until a logging out. By this means, the communication time between the personal computer 2 and each server computer 3 is updated in real time in the communication time file 151. As heretofore described, it is also acceptable that the inputting of the ping command is carried out in the server computer 3.

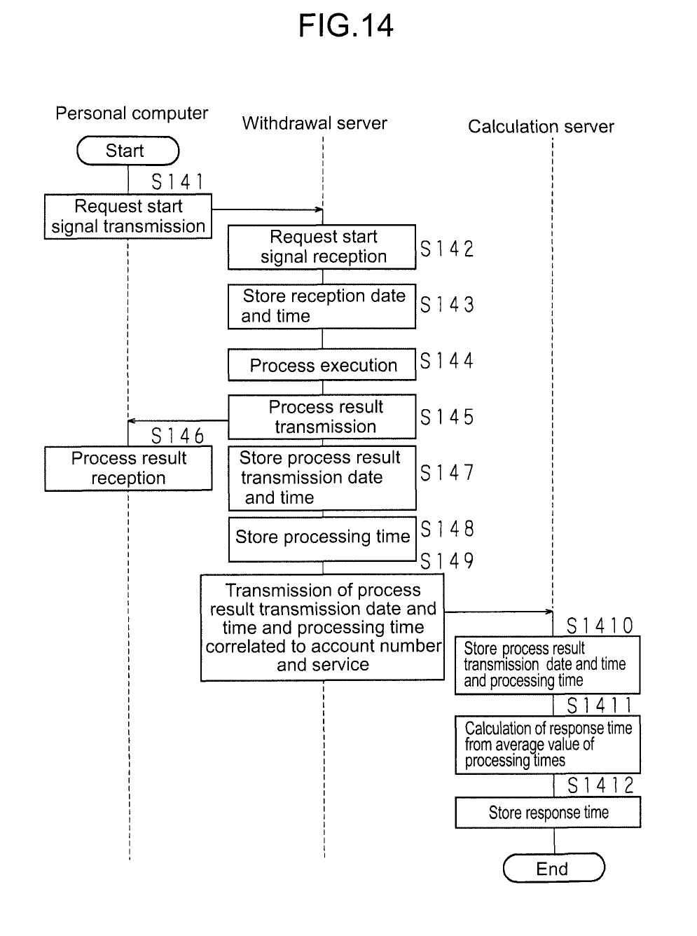

FIG. 14 is a flowchart showing calculation procedures for the processing time and response time. After logging in, the user starts a request for a process, such as the withdrawal process from the withdrawal server 3B. In the event that the start button 242 shown in FIG. 4 is clicked via the input portion 23, the CPU 21 of the personal computer 2 transmits the signal indicating the request start to the withdrawal server 3B (step S141). The withdrawal server 33 receives the signal indicating the request start transmitted from the personal computer 2 (step S142). The CPU 31, based on the date and time information from the timer 38, records the request reception, and the date and time at which the request reception has occurred, as events, correlated to the account number, in the account DB 351 (step S143).

The CPU 31, in response to the request, executes processes such as the balance check and the withdrawal (step S144). The CPU 31 transmits the result of the executed process to the personal computer 2 (step S145). The CPU 21 of the personal computer 2 receives the process result (step S146). The CPU 31 of the withdrawal server 3B, based on the transmission from the timer 38, records the process result transmission date and time of step S145, correlated to the account number, as the process result transmission date and time event in the account DB 351 (step S147). The CPU 31 calculates the processing time, based on the difference between the reception date and time of step S143 and the process result transmission date and time of step S147, which are recorded in the account DB 351, and records the calculated processing time in the account BD 351 (step S148).

The CPU 31 transmits the process result transmission date and time and processing time, which are recorded in the account DB 351, correlated to the account number and service, to the calculation server 1 (step S149). The CPU 11 of the calculation server 1 records the transmitted process result transmission date and time and processing time, for each service and account number, in the response time file 152, as shown in FIG. 9 (step S1410). Although an example is described in which the CPU 31 of the withdrawal server 3B executes the calculation of the processing time, it is also acceptable to arrange in such a way that the reception date and time of step S143, and the process result transmission date and time of step S147, are transmitted from the withdrawal server 3B to the calculation server 1, and the CPU 11 of the calculation server 1 calculates the processing time based on the difference between them.

The CPU 11 reads the predetermined number of days' worth of processing times, for each service, recorded in the response time file 152, and calculates the response time for each service from the average value of the read processing times (step S1411)

Then, the CPU 11 records the response time calculated for each service in the response time file 152 (step S1412). Regarding the response time, as heretofore described, it is also acceptable to calculate one response time for each individual service, or to calculate the average value of the processing times of each account number, and to make it the response time. Also, as heretofore described, rather than simply taking the average value of the processing times, it is also acceptable to multiply by coefficients, in such a way that the weights become greater the newer the history of the process result transmission date and time, and to make the average value thereof the response time. Furthermore, it is also acceptable to make the average value of the three immediately preceding processing times the response time. By this means, the response time for each server computer 3, corresponding to each service, is calculated.

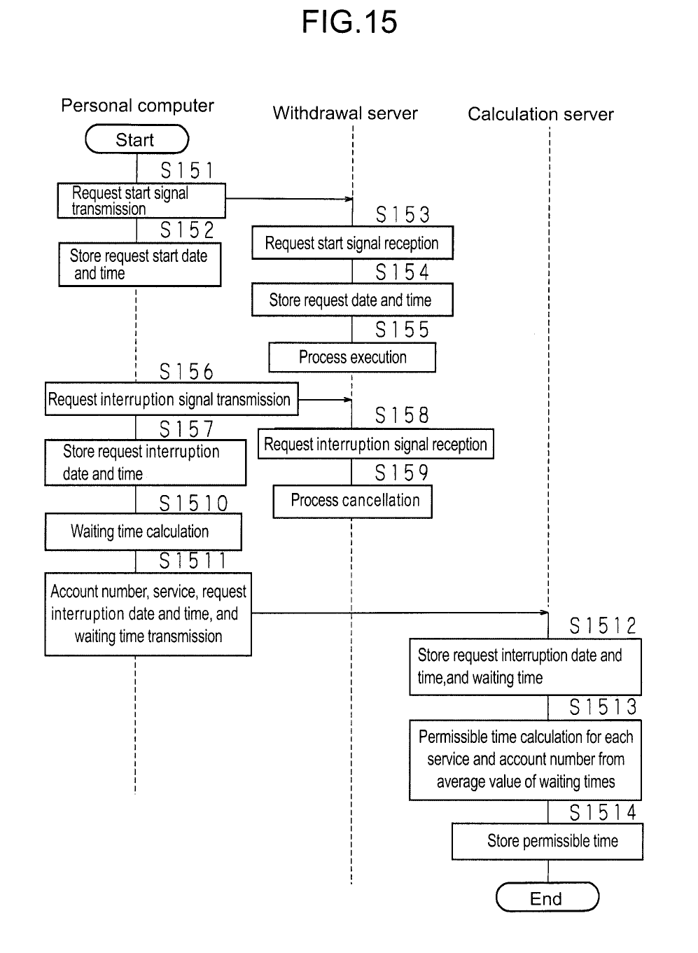

FIG. 15 is a flowchart showing calculation procedures for the waiting time and permissible time. After logging in, the user starts the request for a process, such as the withdrawal process from the withdrawal server 3B. In the event that the start button 242 shown in FIG. 4 is clicked via the input portion 23, the CPU 21 of the personal computer 2 transmits the signal indicating the request start to the withdrawal server 3B (step S151). The CPU 21 of the personal computer 2, based on the transmission from the timer 28, records the date and time at which the request start has occurred in the RAM 22 (step S152). The withdrawal server 3B receives the signal indicating the request start transmitted from the personal computer 2 (step S153). The CPU 31, based on the date and time information from the timer 38, records the request reception, and the date and time at which the request reception has occurred, as events, correlated to the account number, in the account DB 351 (step S154).

The CPU 31, in response to the request, executes processes such as the balance check and the withdrawal (step S155). During the process, the user, before obtaining the process result, clicks the cancel button 243 shown in FIG. 4, via the input portion 23 of the personal computer 2. The CPU 21 receives the signal announcing the interruption of the request, and transmits the request interruption signal to the withdrawal server 3B, via the communication portion 26 (step S156). Also, the CPU 21 of the personal computer 2, based on the transmission from the timer 28, records the date and time at which the request interruption has occurred in the RAM 22 (step S157).

The CPU 31 of the withdrawal server 3B receives the transmitted request interruption signal (step S158), and interrupts the process relating to the withdrawal (step S159). The CPU 21 of the personal computer 2 calculates the waiting time based on the difference between the request start date and time recorded in step S152, and the request interruption date and time recorded in step S157 (step S1510). The CPU 21 transmits the account number, the service, the request interruption date and time, and the calculated waiting time to the calculation server 1 (step S1511). The CPU 11 of the calculation server 1 receives the transmitted account number, service, request interruption date and time, and waiting time, and records the request interruption date and time, and waiting time, for each individual service and account number, in the permissible time file 153 (step S1512).

The CPU 11 reads the predetermined number of days' worth of waiting times relating to the account number, for each service and, by calculating the average value thereof, calculates the permissible time for each individual service and account number (step S1513). The CPU 11 records the calculated permissible time in the permissible time file 153, as in FIG. 10 (step S1514). It is also acceptable that the CPU 21 of the personal computer 2 transmits the request start date and time recorded in step S152, and the request interruption date and time recorded in step S157, to the calculation server 1, and that the CPU 11 of the calculation server 1 calculates the waiting time from the difference between them. Also, it is also acceptable to arrange in such a way that the CPU 31 of the withdrawal server 3B, based on the request date and time recorded in step S154, and the date and time at which the request interruption signal is received in step S158, calculates the waiting time from the difference between them, and transmits it to the calculation server 1. Furthermore, as heretofore described, it is also acceptable that, apart from the permissible time being the average value, and apart from the waiting time relating to the immediately preceding interruption time being made the permissible time, the average value of all previous waiting times, or furthermore, multiplying by the coefficients of which the weights become greater the newer the history becomes, the average value thereof is made the permissible time.

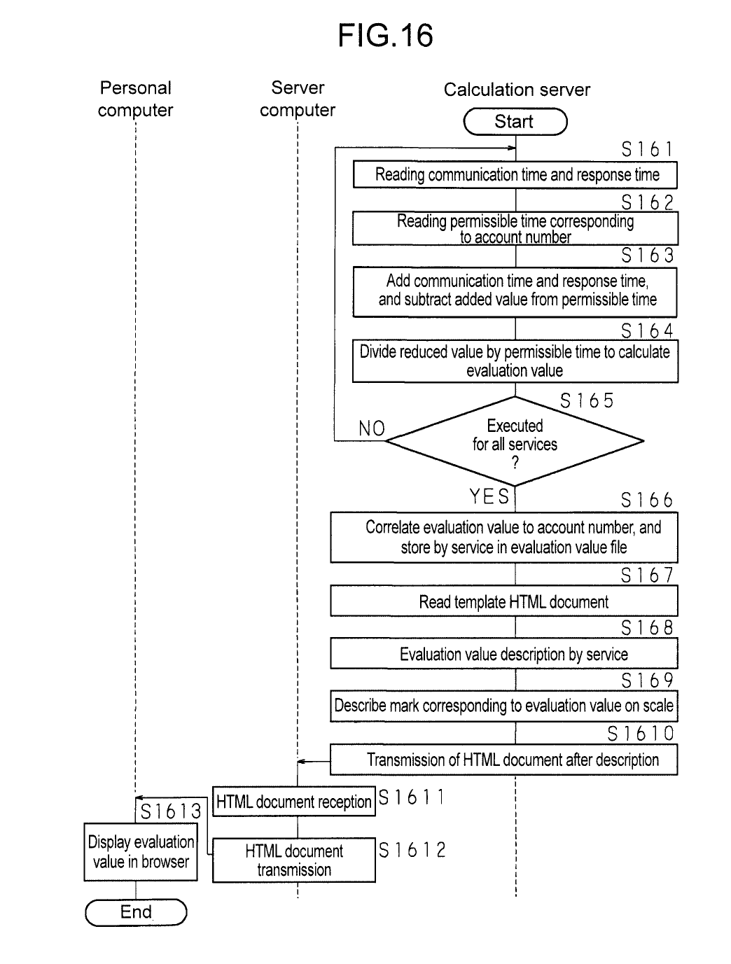

FIG. 16 is a flowchart showing an evaluation value calculation procedure. The CPU 11 of the calculation server 1, after the process of step S1311 shown in FIG. 13, calculates the evaluation value, for each service, for each account number, in accordance with the following procedure. The CPU 11 reads the communication time of the account number recorded in step S1311 from the communication time file 151, and furthermore, reads the response time recorded in step S1412 from the response time file 152 (step S161). The CPU 11 reads the permissible time, corresponding to the account number, recorded in step S1514 from the permissible time file 153 (step S162). The CPU 11 adds together the read communication time and response time, and subtracts the aggregated value from the read permissible time (step S163).

The CPU 11 calculates the evaluation value by dividing the value reduced in step S163 by the permissible time (step S164). The CPU 11 determines whether or not the processes of steps S161 to S164 have been executed for all the services (step S165). If it is determined that the processes have not been executed for all the services (No in step S165), the CPU 11 shifts to step S161, and calculates, for example, the evaluation value relating to the relevant account number for the investment trust service.

Meanwhile, if it is determined that the processes have been executed for all the services (Yes in step S165), the CPU 11 records the calculated evaluation value for each individual service, correlated to the account number, in the evaluation value file 154, as in FIG. 11 (step S166). The CPU 11 reads a template HTML document, which forms a base, from the memory 15 (step S167). Herein, the template HTML document is one in which the evaluation value, and the • mark corresponding to the evaluation value in the three scales (horizontal bar graphs), in FIG. 12 are not described. The CPU 11 reads the evaluation value for each service from the evaluation value file 154, and describes it in the read template HTML document (step S168). Furthermore, the CPU 11 describes the mark corresponding to the evaluation value in each scale in the template HTML document (step S169). In this way, the HTML document shown in FIG. 12, in which the evaluation value is described, is completed.

The CPU 11 transmits the described HTML document to the server computer 3 (step S1610). The CPU 31 of the server computer 3 receives the transmitted HTML document (step S1611), and transmits the received, described HTML document to the personal computer 2 corresponding to the account number for which the authentication has been carried out in step S132 (step S1612). The CPU 21 of the personal computer 2 receives the described HTML document and, as in FIG. 12, displays the evaluation value for each service on the browser 252 (step S1613). Although, in the embodiment, the description is given of the aspect in which the described HTML document is transmitted to the personal computer 2 via the server computer 3, it is also acceptable to arrange in such a way that the described HTML document is transmitted directly from the calculation server 1 to the personal computer 2. In this case, the CPU 11 of the calculation server 1, referring to the IP address of the personal computer 2 corresponding to the account number, transmits the described HTML document to the personal computer 2. The CPU 21 of the personal computer 2 starts up the browser 252 anew, and displays the evaluation value on the browser 252.

### Second Embodiment

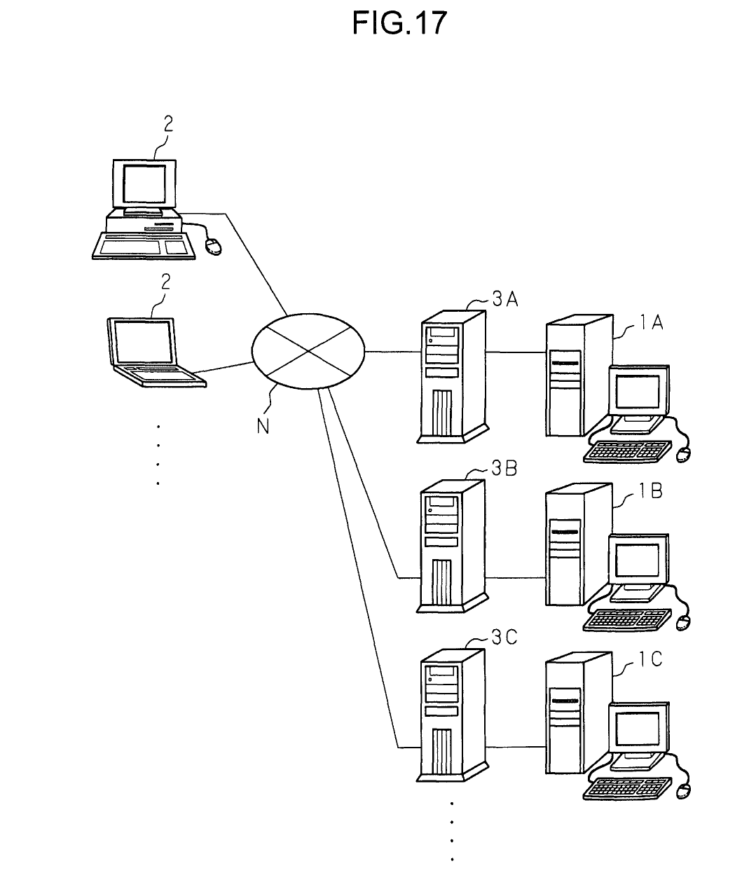

Although, in the first embodiment, the configuration is such that the calculation server 1 calculates the response time and permissible time for each service, it is also acceptable to arrange in such a way that the calculation server 1 is connected to each server computer 3, and the response time and permissible time calculated for each individual service. FIG. 17 is a schematic diagram showing an outline of a processing speed calculation system according to a second embodiment. As shown in the figure, a deposit calculation server 1A is connected to a deposit server 3A, a withdrawal calculation server 1B is connected to a withdrawal server 3B, and an investment trust calculation server 1C is connected to an investment trust server 3C. In the first embodiment, the calculation server 1 calculates the response time and permissible time for each service and, as shown in FIGS. 9 and 10, records the response time and permissible time for each service in the response time file 152 and permissible time file 153. In the second embodiment, each calculation server calculates a response time and permissible time corresponding to its own service, and records them in the response time file 152 and permissible time file 153.

For example, the withdrawal calculation server 1B calculates the response time and permissible time relating to the withdrawal service, and records them in the response time file 152 and permissible time file 153. Then, at a predetermined timing, it accesses the deposit calculation server 1A and investment trust calculation server 1C, and carries out a synchronization with the response time file 152 and permissible time file 153 which they record. Then, it is sufficient that, for example, the withdrawal calculation server 1B calculates the evaluation value, for each service, for each account number, by means of the heretofore described process, transmits the evaluation value calculated for each service to the deposit calculation server 1A and investment trust calculation server 1C, and updates the evaluation value file 154.

The second embodiment being configured in the heretofore described way, as other configurations and operations are the same as those of the first embodiment, identical reference numbers are affixed to corresponding portions, and a detailed description is omitted.

### Third Embodiment

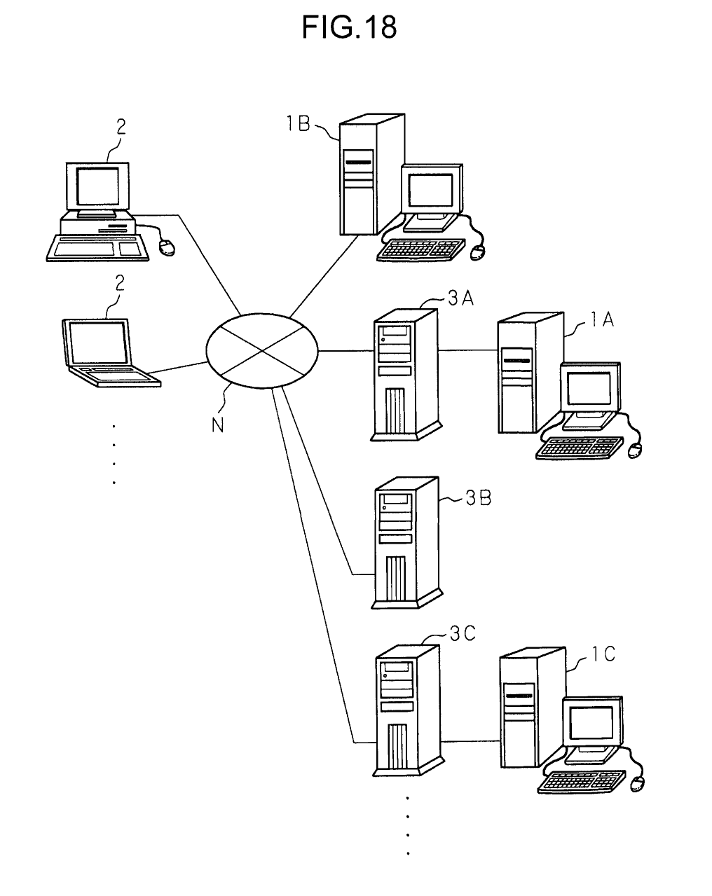

It is also acceptable that it is a configuration which combines the first embodiment and the second embodiment. FIG. 18 is a schematic diagram showing an outline of a processing speed calculation system according to a third embodiment. In the third embodiment, the deposit calculation server 1A is connected to the deposit server 3A, and the investment trust calculation server 1C is connected to the investment trust server 3C. The withdrawal calculation server 1B is a server which brings together the deposit calculation server 1A and investment trust calculation server 1C. The deposit calculation server 1A, the withdrawal calculation server 1B, and the investment trust calculation server 1C, in the same way as in the second embodiment, calculate the response time and permissible time relating to their own service. The deposit calculation server 1A transmits the calculated response time and permissible time relating to the deposit service, at an appropriate timing, to the withdrawal calculation server 1B.

In the same way, the investment trust calculation server 1C transmits the calculated response time and permissible time relating to the investment trust service, at an appropriate timing, to the withdrawal calculation server 1B. The withdrawal calculation server 1B, in the same way as in the first embodiment, calculates the response time and permissible time relating to its own service. By this means, the response times and permissible times relating to all the services are recorded in the withdrawal calculation server 1B, in the same way as in the calculation server 1 of the first embodiment. Finally, the withdrawal calculation server 1B transmits the calculated evaluation value to the withdrawal server 3B, the deposit server 3A, and the investment trust server 3C. In this way, it is also acceptable to arrange in such a way as to distribute and execute the processes of the calculation server 1 in the first embodiment, and to share data after the execution at an appropriate timing.

In the third embodiment, as other configurations and operations are the same as those of the first and second embodiments, identical reference numbers are affixed to corresponding portions, and a detailed description is omitted.

### Fourth Embodiment

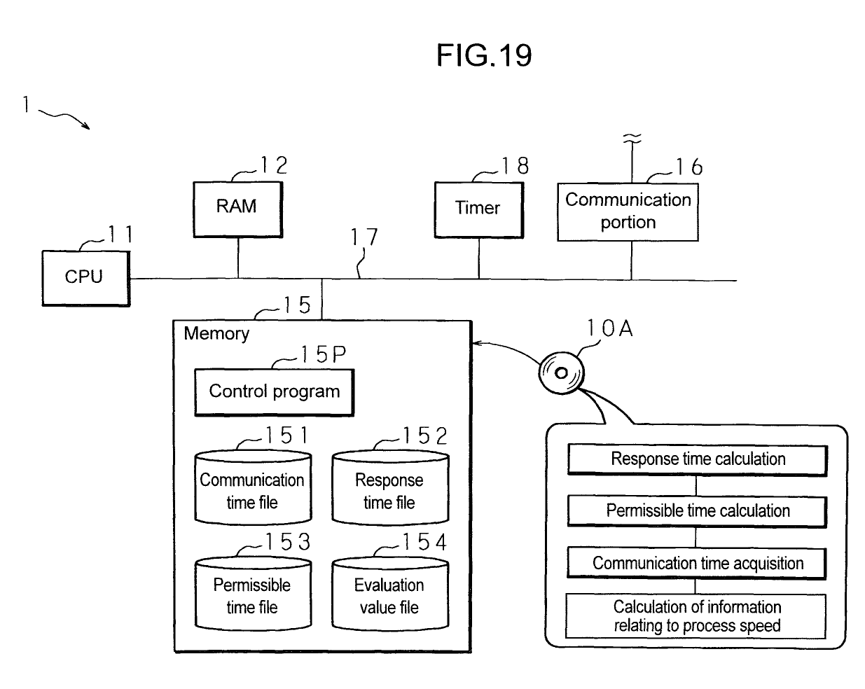

FIG. 19 is a block diagram showing a configuration of a calculation server 1 according to a fourth embodiment. A program for causing the calculation server 1 according to the fourth embodiment to operate can also be provided, as in the fourth embodiment, by a portable recording medium 10A, such as a CD-ROM. Furthermore, it is also possible to download a computer program from an unshown server computer, via the communication network N. Hereafter, contents thereof will be described.

The portable recording medium 10A, on which is recorded a program which causes the calculation of the response time, causes the calculation of the permissible time, causes the acquisition of the communication time, and causes the calculation of the information relating to the processing speed, is inserted into an unshown recording medium reading device of the calculation server 1 shown in FIG. 19, and the program is installed in the control program 15P of the memory 15. Alternatively, it is also acceptable to arrange in such a way that such a program is downloaded, via the communication portion 16, from an external, unshown server computer, and installed in the memory 15. The program is loaded into the RAM 12, and executed. By this means, it functions as the heretofore described kind of calculation server 1 of the invention.

The fourth embodiment being configured in the heretofore described way, as other configurations and operations are the same as those of the first to third embodiments, identical reference numbers are affixed to corresponding portions, and a detailed description is omitted.

### ADVANTAGE OF INVENTION

In the invention, a response time calculation part calculates a response time, based on a transmitted time which each processing device needs for a process, for each processing device, and a permissible time calculation part calculates a permissible time, based on a transmitted time from a request start to a request interruption corresponding to identification information, for each item of identification information. Also, an acquisition part acquires a communication time needed for a transmission and reception of information between a process request device and a processing device. Then, a calculation part of a calculation device, based on the communication time, the response time, and the permissible time corresponding to the identification information, calculates information relating to a processing speed, for each processing device, for each item of identification information. Alternatively, the calculation part of the calculation device, based on the response time and the permissible time corresponding to the identification information, calculates the information relating to the processing speed, for each processing device, for each item of identification information. By configuring in this way, it is possible to calculate more detailed processing speed related information, considering a communication environment of each user, and a degree of tolerance for the user's response time.

In the invention, a transmission part transmits information relating to the processing speed, calculated for each processing device by the calculation part, to the process request device or processing device corresponding to the identification information. The information relating to the processing speed of each processing device is displayed in the process request device. Consequently, information relating to an individual processing speed for each user is provided, as a result of which, it being possible for the user to select a processing device with which it is possible to receive a provision of a service more quickly, the invention achieves an excellent advantage.

What is claimed is:

1. A method for calculating, by a calculation device, information relating to a processing speed for a plurality of processing devices which execute various kinds of processes in response to a request from a process request device, comprising the steps of:
transmitting a time which each processing device needs for a process, to the calculation device, by means of each processing device;
transmitting a time from a start of a request for the process, from the process request device to one of the processing devices, to an interruption of the request for the process, correlated to identification information corresponding to the process request device, to the calculation device by means of the process request device;
transmitting a communication time needed for a transmission and reception of information between the process request device and the processing device to the calculation device, by means of the process request device;
calculating a response time for each processing device, by means of the calculation device, based on the transmitted time which each processing device needs for the process;
calculating a permissible time for each item of identification information, by means of the calculation device, based on the transmitted time from the start of a request for the process to the interruption of the request for the process corresponding to the identification information; and
calculating, by means of the calculation device, information relating to a processing speed, for each processing device, for each item of identification information, based on the transmitted communication time, the response time calculated by means of the response time calculation step, and the permissible time corresponding to the identification information calculated by means of the permissible time calculation step.

2. A processing speed calculation system, comprising:
a processing device which, in response to a request from a process request device connected thereto via a communication network, executes various kinds of processes;
a calculation device which calculates information relating to a processing speed for the processing device;
a first transmitting part which transmits a time which each processing device needs for a process, to the calculation device, by means of each processing device;
a second transmitting part which transmits a time from a start of a request for the process, from the process request device to the processing device, to an interruption of the request for the process, correlated to identification information corresponding to the process request device, to the calculation device by means of the process request device;
a third transmitting part which transmits a communication time needed for a transmission and reception of information between the process request device and the processing device to the calculation device, by means of the process request device;
a response time calculation part which calculates a response time for each processing device, by means of the calculation device, based on the transmitted time which each processing device needs for the process;
a permissible time calculation part which calculates a permissible time for each item of identification information, by means of the calculation device, based on the transmitted time from the request start to the request interruption corresponding to the identification information; and
a process speed calculation part which calculates, by means of the calculation device, information relating to a processing speed, for each processing device, for each item of identification information, based on the transmitted communication time, the response time calculated by the response time calculation part, and the permissible time corresponding to the identification information calculated by the permissible time calculation part.

3. The processing speed calculation system according to claim 2, further comprising:
a transmission part which transmits information relating to the processing speed, calculated for each processing device, for each item of identification information, by the calculation part, to the process request device or processing device corresponding to the identification information, by means of the calculation device.

4. A calculation device for calculating information relating to a processing speed for a plurality of processing devices which execute various kinds of processes in response to a request from a process request device, comprising:
a response time calculation part which calculates a response time for each processing device, based on a time which each processing device needs for a process;
a permissible time calculation part which calculates a permissible time for each item of identification information corresponding to the process request device, based on a time from a start of a request for the process, from the process request device to the processing device, to an interruption of the request for the process; and
a calculation part which calculates information relating to a processing speed, for each processing device, for each item of identification information, based on the response time calculated by the response time calculation part, and the permissible time corresponding to the identification information calculated by the permissible time calculation part.

5. The calculation device according to claim 4, wherein
the calculation part, based on a ratio between the response time calculated by the response time calculation part, and the permissible time corresponding to the identification information calculated by the permissible time calculation part, calculates the information relating to the processing speed, for each processing device, for each item of identification information.

6. A calculation device for calculating information relating to a processing speed for a plurality of processing devices which execute various kinds of processes in response to a request from a process request device, comprising:
a response time calculation part which calculates a response time for each processing device, based on a time which each processing device needs for a process;
a permissible time calculation part which calculates a permissible time for each item of identification information corresponding to the process request device, based on a time from a start of a request for the process, from the process request device to the processing device, to an interruption of the request for the process;
an acquisition part which acquires a communication time needed for a transmission and reception of information between the process request device and the processing device; and
a calculation part which calculates the information relating to the processing speed, for each processing device, for each item of identification information, based on the communication time acquired by the acquisition part, the response time calculated by the response time calculation part, and the permissible time corresponding to the identification information calculated by the permissible time calculation part.

7. The calculation device according to claim 6, wherein
the calculation part adds the response time calculated by the response time calculation part to the communication time acquired by the acquisition part, and calculates the information relating to the processing speed, for each processing device, for each item of identification information, based on a ratio between an aggregate value and the permissible time corresponding to the identification information calculated by the permissible time calculation part.

8. The calculation device according to claim 6 or 7, wherein
the calculation part adds the response time calculated by the response time calculation part to the communication time acquired by the acquisition part, calculates a difference between an aggregate value and the permissible time corresponding to the identification information calculated by the permissible time calculation part and, by dividing the calculated difference by the permissible time, calculates the information relating to the processing speed, for each processing device, for each item of identification information.

9. The calculation device according to claim 6, wherein
the response time calculation part reads a history of times needed for the process for each processing device, from a memory which stores the history of the times which each processing device has needed for the processes, and calculates the response time for each processing device, based on the read history of times.

10. The calculation device according to claim 6, wherein
the permissible time calculation part, for each item of identification information of users who use the process request device, reads a history of times for each item of identification information, from a memory which stores a history of times from the start of the request for the process, from the process request device to the processing device, to the interruption of the request for the process, and calculates the permissible time for each item of identification information, based on the read history of times.

11. The calculation device according to claim 6, wherein
the acquisition part is configured in such a way as to acquire, from the process request device, a communication time needed for a transmission and reception of a signal relating to a predetermined command transmitted from the process request device to the processing device.

12. The calculation device according to claim 6, further comprising:
a transmission part which transmits the information relating to the processing speed, calculated for each processing device, for each item of identification information, by the calculation part, to the process request device or processing device corresponding to the identification information.

13. A computer-readable storage medium storing a program to calculate information relating to a processing speed for a plurality of processing devices which execute various kinds of processes in response to a request from a process request device, the program causing a computer to function as:
a response time calculation step that calculates a response time for each processing device, based on a time which each processing device needs for the process;
a permissible time calculation step that calculates a permissible time for each item of identification information corresponding to the process request device, based on a time from a start of a request for the process, from the process request device to the processing device, to an interruption of a request for the process;
an acquisition step that acquires a communication time needed for a transmission and reception of information between the process request device and the processing device; and
a calculation step that calculates the information relating to the processing speed, for each processing device, for each item of identification information, based on the communication time acquired by the acquisition step, the response time calculated by the response time calculation step, and the permissible time corresponding to the identification information calculated by the permissible time calculation step.
